(19) United States
(12) Patent Application Publication
(10) Pub. No.: US 2004/0009260 A1
(43) Pub. Date: Jan. 15, 2004

(54) Injection-moulding tool for the production of information carriers in disc form

(76) Inventor: Markus Gabriel, Buttwil (CH)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/396,120

(22) Filed: Mar. 25, 2003

(30) Foreign Application Priority Data
Mar. 25, 2002 (CH) 0518/02

(51) Int. Cl. B29C 45/73

(52) U.S. Cl. 425/810; 425/547; 425/552; 425/542; 425/556

(57) ABSTRACT

An injection-moulding tool (10) for the production of mouldings in disc form, in particular in the form of information carriers such as CDs and/or DVDs, which injection-moulding tool (10), to form an injection mould (25), includes a first and a second mirror block (11 and 12, respectively), which lie opposite each other and are movable in relation to each other for the opening and closing of the mould, and also a form ring (20), which concentrically encloses the first mirror block (11) and closes off the injection mould (25) towards the outer edge and is movable in relation to the first mirror block (11), better process stability, better quality of the mouldings and shorter waiting times during starting-up are achieved, inter alia, by facilities for active temperature control of the form ring (20) being provided.

### CROSS-REFERENCE TO RELATED APPLICATION

This application claims priority to Swiss Application No. 0518/02, filed Mar. 25, 2002, which application is hereby incorporated by reference in its entirety.

1. Field of the Invention

The present invention relates to the field of injection-moulding technology and, more particularly, to an injection-moulding tool for the production of mouldings in disc form, in particular in the form of information carriers such as CDs and/or DVDs.

2. Discussion of the Present Technology

For producing optically readable information carriers such as audio CDs, CD-ROMs, video CDs or DVDs, injection-moulding tools which form an injection mould by means of two (cylindrical) mirror blocks lying opposite each other and movable in relation to each other are used. On one of the two mirror blocks there is usually releasably fastened a thin, disc-shaped stamper, which stamps the tracks containing the information during the injection moulding of the information carrier being formed. At the outer edge, the injection mould is often bounded by a form ring, which concentrically surrounds one of the mirror blocks.

The form ring projects beyond the planar moulding surface of the mirror block enclosed by it and is displaceable in relation to this mirror block in the axial direction. If the injection mould is closed by an axial movement of the two mirror blocks towards each other, the form ring comes to rest on the opposite mirror block on account of the projection and closes the mould, while the mirror block concentrically enclosed by it is at a predetermined distance from the opposite mirror block. The hot plastic is then injected under high pressure into the disc-shaped cavity formed in this way. Once the cavity of the injection mould has been filled, if need be the mirror block enclosed by the form ring is moved a little towards the other mirror block to achieve a high quality of the information carrier, while the form ring remains fixed in place on the opposite mirror block on account of the stop. An injection-moulding tool of the type discussed above is detailed in WO-A1-99/37471.

Although the above discussed injection-moulding tool is accepted, there are drawbacks. More particularly, the relative movement taking place between the mirror block and the form ring enclosing it gives rise to problems for the following reasons: in order that the form ring can slide freely over the mirror block during the relative movement, a certain fit is necessary. If this fit is too large, plastic can get into the gap during injection and forms undesired flash on the moulded information carrier disc. If, on the other hand, the fit is too close, excessive fraction values may occur, in particular if the mirror block and form ring are at different temperatures, hindering the relative movement and, because both parts are generally made of steel, possibly leading to seizing or jamming of the form ring on the mirror block.

In order to ensure a low sliding friction between the mirror block and the form ring when there is a relatively close fit, it has already been proposed in WO-A1-99/37471 to provide the surfaces sliding on one another of the mirror block and the form ring with a special coating which reduces the friction. However, it is disadvantageous in this case that the coating of the parts entails high expenditure, and that the coating generally influences the heat removal from the injection mould.

In EP-A1-0 899 075, to ensure a good relative mobility between a mirror block and a ring concentrically enclosing the mirror block, a linear ball bearing (75 in FIG. 5) is provided between the two parts. However, in this case, the ring is not a form ring which forms part of the injection mould, but a guide ring which assists the centering of the two mirror blocks with respect to each other.

As can now be appreciated, it would be advantageous to provide an injection-moulding tool and process for making mouldings in disc form that does not have the drawbacks of the presently available technology.

### SUMMARY OF THE INVENTION

The invention provides an injection-moulding tool for the production of information carriers in disc form which avoids the disadvantages of known injection-moulding tools and is distinguished in particular, but not exclusively, by better process stability, better quality of the mouldings and shorter waiting times during starting-up. Specifically, it concerns the improvement of an injection-moulding tool for the production of mouldings in disc form, in particular in the form of information carriers such as CDs and/or DVDs, which injection-moulding tool, to form an injection mould, includes a first and a second mirror block, which lie opposite each other and are movable in relation to each other for the opening and closing of the mould, and also a form ring which concentrically encloses the first mirror block and closes off the injection mould towards the outer edge and is movable in relation to the first mirror block.

A non-limiting embodiment of the invention provides facilities for the active temperature control of the form ring. Temperature control is to be understood in this case as meaning the setting of a specific temperature of the form ring, i.e., active cooling or active heating of the form ring may be concerned, for example. The essence of the invention is consequently not simply to allow the temperature of the form ring to be determined by the temperature of the parts or air surrounding it and to be influenced by the heat transfer thereby occurring, but to bring the form ring actively to the desired temperature, or keep it there.

This active influencing of the temperature of the form ring is accompanied by non-limiting embodiments of the invention, for instance it allows a symmetrical distribution of the temperature of the mirror block and form ring to be achieved and differentiated thermal expansions of these two components lying directly against each other to be deliberately avoided. Consequently, the amount of wear in the fit is reduced. In addition, the heat balance can be kept stable after interruptions, as occur, for example, when exchanging the stamper.

In addition, however, the advantage that controlled conditions can be created, in particular during the cooling process, by the possible setting of a homogeneous temperature distribution between the mirror block and the form ring is also obtained, so that the quality of the mouldings is increased.

Furthermore, the heating-up phase of an injection-moulding tool of this type can be greatly reduced, since it is usually necessary to wait until the mirror and the form ring are at the desired temperature. According to prior art, this takes place by the mirror block being brought to a desired temperature by corresponding facilities and subsequently waiting until this temperature is also transferred to the form ring. The active temperature control of the form ring of the invention, in this case active heating, consequently allows the heating-up phase to be significantly shortened. Thus, damage to the tool caused by excessively rapid starting-up can be prevented.

Temperature control also has the advantage that the fit between the form ring and the mirror can be made adjustable. While it is usually necessary for a different form ring to be used for different process temperatures, as a result of the different thermal expansion of the form ring and mirror, depending on the desired process temperature, the active temperature control of the form ring, and the consequently associated specifically adjustable thermal expansion of this element, allow the fit to be set according to requirements, i.e., independently of the format, process, and production temperature. Consequently, a temperature range from 45 to 130 degrees Celsius is possible with the same tool design, and even temperatures of up to 200 to 300 degrees Celsius are possible. The tool design is thus independent, inter alia, of the type of plastic (PC, PMMA, etc.).

Influencing of the fit by asymmetric temperatures can also be used to compensate for production tolerances. For instance, hairline formations in the event of excessive play of the fit can be avoided, as well as jamming of the form ring on the mirror. Given a diameter of the mirror of 120 millimeters, a temperature difference of ten degrees Celsius between the mirror and the form ring in this case allows an adaptation of about 0.015 mm (for coefficients of expansion of steel), that is to say significant ranges can be effectively covered in this way. The active setting of an asymmetrical temperature distribution can also be used, however, for specifically heating up the form ring for fitting, in order that it can be easily placed over the mirror block. This prevents the edges from being damaged during fitting.

Active temperature control can in this case be performed from the outside; according to a first preferred non-limiting embodiment of the invention, however, the facilities for temperature control are arranged inside the form ring. In this case, the facilities may be, for example, electrical heating coils; otherwise, the temperature control can preferably be brought about with the aid of a temperature-control medium. Customary heating or cooling media come into consideration as the temperature-control medium. Preferred for use are temperature-controlled air, temperature-controlled steam, or a temperature-controlled liquid medium, particularly preferably on the basis of water and/or organic liquids, which may be provided with additives.

According to a further preferred embodiment, at least one virtually circulating channel through which a temperature-control medium is passed is provided in the form ring. Virtually circulating means in this context that the medium is essentially fed in at one point, circulates one or more times in the form ring, and is subsequently removed at another point. In other words, a single virtually circulating channel may be provided, but it is also possible to provide a channel in the form of a number of turns or a spiral. It is provided here in particular that this temperature-control medium is introduced into the channel by means of a feed from the radial direction, made to circulate in the form ring in the channel, and subsequently expelled from the channel through a discharge in the radial direction and, in the case of the arrangement of a single channel, it is particularly preferred for the feed and discharge to be arranged essentially next to each other on the form ring so that the temperature-control medium in between essentially flows through the entire form ring once in a circulating manner.

Another preferred non-limiting embodiment of the invention is distinguished by the fact that second facilities are arranged, permitting controlled blowing off of the finished moulding in its peripheral region after the mould has been opened. However, this second facilities may also be used in this case without being combined with a temperature-controlled form ring, and already has in itself many advantages. For instance, the arrangement of the second facilities allows shorter removal times to be achieved, there are fewer removal problems, and sticking of the moulding on the mirror can be efficiently counteracted in this way.

According to a further preferred embodiment, the second facilities are formed in the form ring in the form of at least one essentially circulating channel, in which channel a blowing-off medium is conducted, and which channel has a large number of blow-out openings, which are open in the direction of the moulding after the mould has been opened. The blowing-off channel is in this case preferably arranged in the form ring radially inside the temperature-control channel, and it is further preferred for it to be closer to the mirror block, in order that the arrangement of the blow-out openings is made easier. There are preferably between 4 and 30 and, in particular, between 12 and 16, blow-out openings in essentially uniform distribution around the circumference of the form ring.

The blow-out openings in this case preferably allow blowing off of the moulding in the region of its radial outer edge in the axial or conical direction after the mould has been opened, it being provided in particular that, when the mould is closed and the form ring withdrawn, the blow-out openings are automatically closed by parts of the injection-moulding tool in front of them and the blow-out openings are only released when the mould is opened.

The present invention relates furthermore to a method for producing mouldings in disc form, in particular in the form of information carriers such as CDs and/or DVDs, using an injection-moulding tool such as that described above, wherein, in the production process, the facilities are used to keep the form ring at a defined process temperature, or the process is controlled or conducted in a specific way corresponding to a defined temperature profile. In other words, the temperature control can be used for the fixed setting of a predetermined temperature, but it is also possible to adjust the temperature of the form ring according to the process, i.e., to operate a temperature profile, which may be of advantage, for example, in the cooling-down phase of the moulding.

According to a first preferred non-limiting embodiment of the method of the invention, the temperature of the form ring is either set in such a way that it corresponds essentially to the temperature of the further shaping elements of the injection-moulding tool, in particular the first mirror block, or that the temperature of the form ring is set with respect to the temperature of the first mirror block in such a way that the play between the form ring and the mirror block corresponds to a desired value (specific asymmetrical setting of the temperature).

According to a further preferred non-limiting embodiment of the method of the invention, if the second facilities are present, the moulding is released from the mould after the mould has been opened by at least one blowing pulse through blowing-out openings, once the moulding has reached the desired temperature after cooling down.

### BRIEF DESCRIPTION OF THE DRAWINGS

The invention is to be explained in more detail below on the basis of exemplary embodiments in conjunction with the drawings, in which:

FIG. 1 is a longitudinal cross-sectional view through the center of a non-limiting exemplary embodiment of an injection-moulding tool of the invention showing a temperature-controlled form ring according to the invention in a simplified representation; and

FIG. 2 is an exploded view of the portion of FIG. 1 illustrating the region of the form ring according to an alternate non-limiting exemplary embodiment of the invention.

### DESCRIPTION OF THE PREFERRED EMBODIMENTS

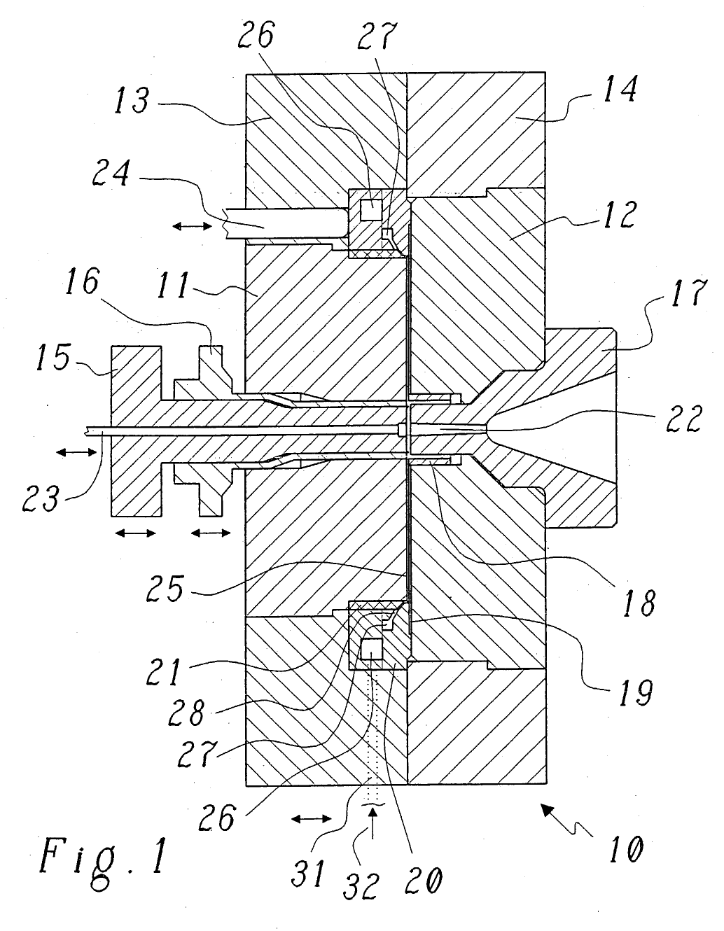

In FIG. 1, a non-limiting preferred exemplary embodiment of an injection-moulding tool according to the invention is reproduced in a longitudinal section through the center of the tool. FIG. 1 is, in this case, simplified to the extent that the necessary screw fittings, springs, seals, and operator-control elements, although present, have not been represented. The injection-moulding tool 10, shown in the closed position, includes as central components a first mirror block 11, a second mirror block 12, and a form ring (also referred to as a “venting ring”) 20 concentrically enclosing the first mirror block 11, which together form the injection mould 25. The mirror blocks 11, 12 are in each case fitted into centering rings 13 and 14, respectively, concentrically surrounding them. The information is stamped into the injection-moulded part, e.g., substrate or data carrier, e.g., the disc during the injection moulding by way of a stamper 19, which, as a thin disc, bears against the moulding surface of the second mirror block 12 and is held in the center by a bushing-shaped stamper holder 18. For the connection of the injection-moulding tool 10 to the nozzle of the injection-moulding machine (not shown) of the type used in the art, a sprue bush 17 reaching through the center of the second mirror block 12 into the injection mould 25 and opening conically outwards is provided.

Arranged opposite the sprue bush 17, lying concentrically in one another and as indicated by the double-headed arrows movable in relation to one another, are an ejector sleeve 16, a punch 15 and a sprue ejector 23. With the sprue ejector 23, the sprue 22 remaining in the inner bore of the sprue bush 17 can be ejected. With the punch 15, the central opening in the injection-moulded data carrier is punched out. With the ejector sleeve 16, the finished data carrier can be ejected after the injection mould 25 has been opened.

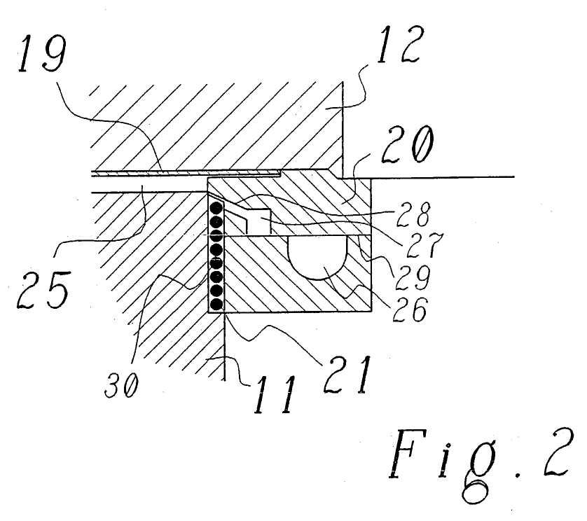

The form ring 20 is displaceably mounted in the centering ring 13 and is pressed by springs (not shown) in the direction of the second mirror block 12. It can be withdrawn if need be by means of a pneumatically driven actuating element 24. Usually, the form ring 20 does not bear with its inner side directly against the outer side of the first mirror block 11, but is separated from the latter by a sliding ring 21, which rests concentrically on the outer side of the first mirror block 11 in an offset provided for this purpose. The sliding ring 21 essentially has the form of a hollow cylinder and preferably consists of copper, a copper alloy such as bronze, or else a plastic material such as polytetrafluoroethylene (PTFE, sold under the trademark Teflon). It consequently provides for the form ring 20, consisting of steel, and the first mirror block 11, consisting of steel, a sliding bearing with good thermal conduction, which ensures improved heat removal in the edge region of the injection mould 25 and consequently ensures improved optical and electrical values in the outer region of the substrate or data carrier, e.g., the disc. On account of the sliding properties of the sliding ring 21, a relatively close fit can be chosen between the sliding ring 21 and the first mirror block 11, so that the formation of flash between the mirror block 11 and form ring 20 is significantly reduced. Instead of a sliding ring, as represented in FIG. 1, a bearing with balls 30 (ball cage, ball grid) may also be used, as shown in FIG. 2. The use of a bearing with balls has the advantage that possibly existing play is better distributed over the circumference.

The form ring 20 has the function of forming the outer edge of the optical data carrier substrate. At the same time, it serves for cavity venting, which is provided by means of a specific venting gap (not shown). In order to carry out the injection-stamping process, the venting ring 20 preferably performs an axial longitudinal movement with every injection operation, e.g., cycle, in order to close the cavity of the tool 10 not closed around the stamping gap. After or during the injection, the tool 10 is closed by the closing force of the injection-moulding machine and moved into its defined end position. In this case, the form ring 20 is withdrawn by the amount of the stamping gap. After removal of the substrate and during the closing operation for starting a new injecting operation, the form ring 20 can be advanced, for example, by means of spring force.

The operation of the currently customary method presents problems, more particularly, small differences in temperature between the mirror block and the form ring lead to different thermal expansions. This has the consequence, on the one hand, of excessive guiding play, and a resultant tendency for flash to form on the substrate and, on the other hand, too little play leads to clamping of the venting ring on the mirror block, with the consequence of over-injection of the substrate.

Different plastics materials (COC, PMMA, PC, etc.), formats such as for instance CD-A-ROM, CD-R(W), DVD, DVD-R(W), Blue Ray, etc., or different stamper conditions demand production temperatures of about 45 degrees Celsius to 130 degrees Celsius. Temperatures of up to 300 degrees Celsius may even be required. In many cases today, the fit between the mirror block and the form ring is produced differently in the micro range according to the (temperature) requirements, with the disadvantage that only one defined process can be conducted with each specific pairing. The desired availability of a single tool, for example to allow all formats to be produced, is not obtained as a result.

Due to the passive heat transfer, according to the presently available technology, from the temperature-controlled mirror block to the not actively temperature-controlled form ring, the heating-up process is very critical and, as a result of the differential expansions, must take place very slowly. Otherwise, malfunctions caused by jamming, etc., occur.

The production of the diameters of the fit must be extremely precise. If the fit is too small, the venting ring tends to seize on the mirror block and leads to premature wear and, as a result, to failure of the components during production, involving high repair costs.

According to the invention and with reference to FIGS. 1 and 2, the form ring 20 thus also comprises a circulating channel 26, in which a cooling medium 32, which is fed in via a first line 31 (shown in FIG. 1 only) from a radial direction and removed via a second line (not shown) in a likewise radial direction, flows and is consequently actively temperature-controlled, in that the cooling medium is set to a specific temperature in a unit not represented.

The form ring 20 includes a channel 27, through which compressed air is passed. At the moment of ejection of the moulding, the moulding can be ejected by pressure pulses via channel 27, which is open in the direction of the moulding via blow-out openings 28, at least when the mould is open. Since a large number of the openings 28 are arranged around the circumference, controlled ejection of the moulding in its peripheral region results.

With respect to the production of the form ring 20, production in two steps is recommended, with a lower half into which the channel 26 is milled being provided. In a separate step, an upper half is machined in such a way that the channel 27 and the opening 28 are formed. Subsequently, the upper and lower halves are joined together and connected at a joint 29 by welding, soldering, HIP (hot-isostatic pressing), or a similar process.

The active temperature control (possible by a temperature-control medium or electrical means) of the form ring 20 thus allows many advantages to be achieved.

The required production temperature can be reached very rapidly, without expensive components being damaged by differences in thermal expansion. The production process can consequently be commenced more quickly.

In the event of interruptions in production, such as stamper changes, repairs, etc., the temperature of the venting ring is not cooled as a result of an absence of heat supplied by the polymer melt if the form ring is actively temperature-controlled. The subsequent start of production can consequently take place unproblematically and straight away.

The temperature control of the form ring 20 has, in principle, the effect that the outer region of the moulded part is warmer, in particular in the cooling-down phase. Consequently, excessively rapid cooling in the edge region is avoided, which leads to an enhancement in the forming of the pits or grooves and prevents distortions of the moulded part.

The production fit of the mirror/form-ring pairing remains exactly the same for all production temperatures (i.e., 45 degrees Celsius to at most 300 degrees Celsius), irrespective of the plastics material or format, if the temperature control of the form ring is used for actively setting an asymmetrical temperature distribution between the mirror block and the form ring.

The fitting of the venting ring is made easier by the temperature of the venting ring being increased. The additional thermal expansion allows the form ring to be fitted more easily and without damaging the highly sensitive outer edge of the mirror block.

The integrated active application of air though the channel 27, which is provided in the form ring 20, has the effect that the moulded part is blown off uniformly over the full circumference through the opening 28. This leads to shorter removal times and avoids interruptions in production as a result of removal errors.

The use of a sliding ring 21 between the first mirror block 11 and the form or venting ring 20 reduces wear and inspections of the expensive components. A metal or a metal alloy with sliding properties, or else a ball bearing (ball cage, ball grid) or the like, may be used as the sliding ring 21.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An injection-moulding tool for the production of mouldings in disc form, comprising:
a first mirror block having a major surface;
a second mirror block having a major surface having a surface area greater than the surface of the first mirror block, the major surface of the first and second blocks mounted in facing relationship and movable toward one another to a closed position and away from one another to an open position; and
a form ring having the first mirror block within the form ring, with surface of the form ring engaging portion of the major surface of the second mirror block when the first and second mirror blocks are in the closed position,
wherein the form ring includes a temperature control system.

2. The injection-moulding tool according to claim 1, wherein the temperature control system is arranged inside the form ring.

3. The injection-moulding tool according to claim 2, wherein the temperature control system includes an electrical heater and/or conduit for passing a temperature-control medium.

4. The injection-moulding tool according to claim 3, wherein the temperature-control medium comprises a fluid selected from the group of air, steam, or a liquid medium, water, organic liquids, and mixtures thereof.

5. The injection-moulding tool according to claim 4, wherein the conduit includes a circulating channel for passing the temperature-control medium, wherein the channel includes an entrance, a feed, a discharge, and a passageway through the body of the ring with the feed and discharge adjacent each other so that the temperature-control medium moving through the passageway essentially flows through the entire form ring.

6. The injection-moulding tool according to claim 5, further including an ejector for controlled displacement of a finished moulding from the second mirror block after the mirror blocks are in the open position.

7. The injection-moulding tool according to claim 6, wherein the ejector is formed in the form ring in the form of at least one essentially circulating channel, through which a blowing-off medium can be moved, the channel having a large number of blow-out openings, which are open in the direction facing the first mirror block.

8. The injection-moulding tool according to claim 7, wherein 4-30 openings are essentially uniformly distributed around circumference of the form ring.

9. The injection-moulding tool according to claim 8, wherein 12-16 openings are essentially uniformly distributed around circumference of the form ring.

10. The injection-moulding tool according to claim 7, wherein the blow-out openings allow blowing off of the moulding in the region of its radial outer edge in the axial or conical direction when the mirror block is in the open position and the blow-out openings are closed when the mirror blocks are in the closed position.

11. The injection-moulding tool according to claim 10, further including a sliding ring partially between the form ring and peripherally of the first mirror block to close the blow-out openings when the first and second mirror blocks are in the closed position.

12. The injection-moulding tool according to claim 1, further including a sliding ring arranged concentrically between the first mirror block and the form ring enclosing it.

13. A method of making moulding in disc form, comprising the steps of:
moving a first mirror block and a second mirror block toward one another to provide a cavity between the facing surfaces of the mirror blocks;
moving a forming medium into the cavity; and
controlling temperature of at least form ring provided around peripheral portions of one of the mirror blocks,
wherein the controlling step is practiced during process for making the mouldings in disc form.

14. The method according to claim 13, wherein the controlling step controls the heating of the form ring to a defined temperature profile.

15. The method according to claim 14, wherein the temperature of the form ring is either set to correspond essentially to the temperature of the mirror blocks.

16. The method according to claim 14, wherein the form ring is around the first mirror block and the temperature of the form ring is set with respect to the temperature of the first mirror block in such a way that the play between the form ring and the mirror block corresponds to a desired value.

17. The method according to claim 14, wherein the discs are selected from the group of CDs, DVDs, and combinations thereof.

18. The method according to claim 14, further including the step of releasing the moulding from the first mirror block after the first and second mirror blocks move away from one another by a blowing pulse after the moulding has reached a desired temperature after cooling down.
